(19) United States
(12) Patent Application Publication
(10) Pub. No.: US 2007/0197214 A1
(43) Pub. Date: Aug. 23, 2007

(54) Encapsulation techniques for handling information services messages for wireless networks

(76) Inventors: Stefano Faccin, Dallas, TX (US); Srinivas Sreemanthula, Flower Mound, TX (US)

Correspondence Address: BRAKE HUGHES BELLERMANN LLP, c/o INTELLEVATE, P.O. BOX 52050, MINNEAPOLIS, MN, 55402, US

(21) Appl. No.: 11/702,030

(22) Filed: Feb. 2, 2007

Related U.S. Application Data
(60) Provisional application No. 60/764,870, filed on Feb. 3, 2006.

(51) Int. Cl. H04Q 7/20

(52) U.S. Cl. 455/433

(57) ABSTRACT

Various embodiments are described relating to encapsulation techniques or handling information services messages for wireless networks. One embodiment comprises generating at a first wireless node a request to transmit a message of a first communications specification to a second wireless node that is not authenticated nor associated with the first wireless node. This embodiment further comprises making a determination that the message is a type that may be transmitted to a node that is not authenticated nor associated with the first node, and encapsulating, based on the determination, at least a portion of the message of the first communications specification into a payload of a frame of a second communications specification. This embodiment further comprises transmitting the frame of the second communications specification from the first wireless node to the second wireless node.

### CROSS-REFERENCE TO RELATED APPLICATIONS

This application claims priority to U.S. Provisional Application Serial Number 60/764,870, filed on Feb. 3, 2006, entitled “Encapsulation Techniques for Handling Information Services Messages for Wireless Networks,” hereby incorporated by reference.

### BACKGROUND

The rapid diffusion of Wireless Local Area Network (WLAN) access and the increasing demand for WLAN coverage is driving the installation of a very large number of Access Points (AP). A variety of other wireless networks have been installed, such as cellular and other wireless networks. Some wireless networks are based upon the Institute of Electrical and Electronics Engineers (IEEE) 802.11 family of industry specifications, such as specifications for IEEE 802.11b, IEEE 802.11g and IEEE 802.11a, etc. A number of working groups are working to improve on this technology or family of specifications.

A recently developed draft specification, IEEE 802.21, “Draft IEEE Standard for Local and Metropolitan Area Networks: Media Independent Handover Services,” December 2005, “provides link layer intelligence and other related network information to upper layers to optimize handovers between heterogeneous media.” The purpose of the IEEE 802.21 specification is to enhance user experience in mobile devices by supporting handovers between heterogeneous networks. Handovers may occur for a variety of reasons, such as due to station movement, changes in wireless link conditions, gaps in radio coverage, because another network or node may be more attractive or offer desired features or capabilities (e.g., higher data rates, Quality of Service or QoS, video service or other services), etc.

The 802.21 specification proposes a Media Independent Handover (MIH) function that provides a set of handover-enabling functions or services within protocol stacks of network elements (e.g., within access points, stations and other nodes). The MIH function generally provides services to upper layers through a MIH service access point (SAP), and obtains services from the lower layers through a variety of technology-dependent interfaces (e.g., different types of MAC and PHY layers).

The 802.21 MIH function provides three sets of services: MIES, MICS, and MIIS. The Media Independent Event Service (MIES), or simply Event Services (ES), supports local and remote events. Events can indicate changes in state and transmission behavior, such as notifying an associated node that a change in link quality, data rate or other change has occurred for the AP, etc. The Media Independent Command Service (MICS), or simply the Command Services (CS), includes a set of commands that may be sent from the higher layers to the lower layers in the protocol stack or reference model, such as commands sent from higher layer to MIH function, and commands sent from MIH function to lower layers (e.g., MAC and/or PHY). The MIES (Event Services) and MICS (Command Services) generally have little or no meaning or relevance between two nodes unless the two nodes are authenticated and associated with each other.

The third set of MIH services is the Media Independent Information Service (MIIS), or simply the Information Services (IS). MIIS generally provides a set of Information Elements, including a query/response structure to allow nodes to discover and obtain network information, such as: information about available network in a geographical area, address and/or data rate information for a node or point of attachment, information about capabilities or services provided by a node (e.g., AP) or network point of attachment (such as QoS, VPN services, specific data rates, video services), cost information, and other network information. Unfortunately, such a set of MIIS services may be currently impractical for 802.11 based WLAN networks, where stations are not permitted to exchange data frames with an AP until the station and AP have been Authenticated and Associated.

### SUMMARY

Various embodiments are described relating to encapsulation techniques or handling information services messages for wireless networks.

According to an example embodiment, a method of requesting network information is provided. The method may include, for example: determining that a request message for network information (e.g., 802.21 MIIS message or other message) may be transmitted to a node (such as a wireless node or network point of attachment) before authenticating or associating with the node. The method also includes encapsulating at least a portion of the request message for network information in one or more information elements in a management frame (e.g., in an 802.11 management frame), and transmitting the management frame to the node.

In an example embodiment, at least a portion of the request message may be encapsulated in one or more Information Elements of a management frame. For example, an existing 802.11 management frame, such as a Probe Request/Probe Response may be extended to encapsulate and transmit at least a portion of a MIIS message. Alternatively, a new or dedicated management frame, such as an 802.11 Transport Request/Response frame may be used. In an example embodiment, a payload of the MIH (or MIIS) request message may be segmented and transported in one or more 802.11 Information Elements designed to carry upper layer information (such as, for example, a new 802.11 Information Element referred to herein as an Upper_Layer_Info_Envelope, to carry or transport the MIH message payload). In addition, a MIH IS message type information element may be generated and provided in the payload of the 802.11 management frame to identify the type of MIH IS message that is being transported in the management frame.

In another example embodiment, a method may be provided that may include: generating at a first wireless node a request to transmit a message of a first communications specification (or standard), such as 802.21 for example, to a second wireless node that is not Authenticated nor Associated with the first wireless node; making a determination that the message is a type that may be transmitted to a node that is not Authenticated nor Associated with the first node; encapsulating, based on the determination, at least a portion (e.g., the payload) of the message of the first communications specification (e.g., an 802.21 MIIS message) into a payload of a frame of a second communications specification (e.g., encapsulating the payload of the 802.21 MIH IS message into an 802.11 management frame); and transmitting the frame of the second communications specification (e.g., 802.11 management frame) from the first wireless node to the second wireless node. At the second wireless node, the frame is received, and the original message of the first communications specification may be regenerated or re-assembled based on the MIH IS message type IE and the MIH message payload that is encapsulated in the frame. The MIH IS message may then be processed, or forwarded to another node for processing, for example.

Another example embodiment is an apparatus provided in a first node for wireless communication, the apparatus comprising a controller, a memory coupled to the controller, and a wireless transceiver coupled to the controller. In this embodiment, the apparatus is adapted to generate a request to transmit a message of a first communications specification to a second wireless node that is not authenticated nor associated with the first wireless node, to make a determination that the message is a type that may be transmitted to a node that is not authenticated nor associated with the first node, to encapsulate, based on the determination, at least a portion of the message of the first communications specification into a payload of a frame of a second communications specification, and to transmit the frame of the second communications specification from the first wireless node to the second wireless node.

Although IEEE 802.11 and IEEE 802.21 family of standards or specifications are used herein to illustrate various example embodiments, the various embodiments are not limited to 802.21 nor 802.11, and may be applied to any wireless technology, including to any wireless specifications or standards.

### BRIEF DESCRIPTION OF THE DRAWINGS

FIG. 1 is a diagram illustrating a wireless network according to an example embodiment.

FIG. 2 is a block diagram of a protocol stack which may be provided in a wireless node according to an example embodiment.

FIG. 3 is a diagram illustrating an encapsulation of a MIH message into a management frame according to an example embodiment.

FIG. 4 is a flow chart illustrating operation of a node according to an example embodiment.

FIG. 5 is a flow chart illustrating operation of a node according to an example embodiment.

FIG. 6 is a block diagram illustrating an apparatus that may be provided in a wireless node according to an example embodiment.

### DETAILED DESCRIPTION

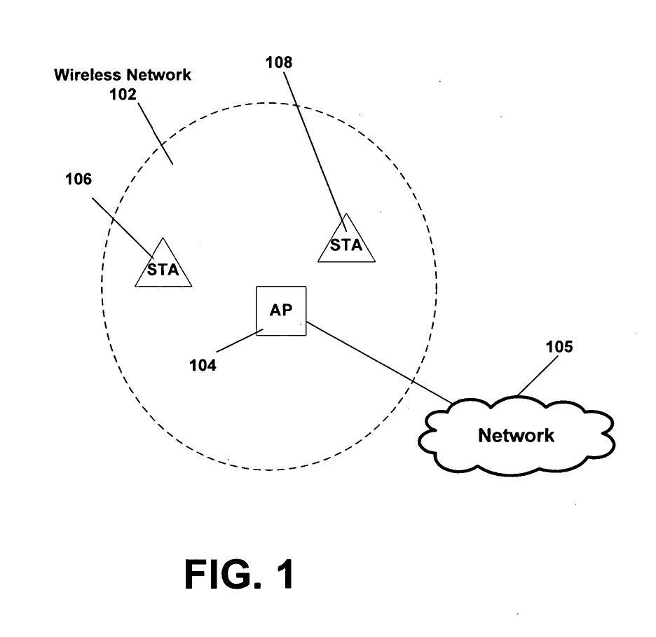

Referring to the Figures in which like numerals indicate like elements, FIG. 1 is a diagram illustrating a wireless network according to an example embodiment. Wireless network 102 may include a number of wireless nodes or stations, such as an access point (AP) 104 or base station and one or more mobile stations, such as stations 106 and 108. While only one AP and two mobile stations are shown in wireless network 102, any number of APs and stations may be provided. Each station in network 102 (e.g., stations 106, 108) may be in wireless communication with the AP 104, and may even be in direct communication with each other. AP 104 may be coupled to a fixed network 105, such as a Local Area Network (LAN), Wide Area Network (WAN), the Internet, etc., and may also be coupled to other wireless networks.

The various embodiments described herein may be applicable to a wide variety of networks and technologies, such as WLAN networks (e.g., IEEE 802.11 type networks), cellular networks, radio networks, or other wireless networks. In another example embodiment, the various examples and embodiments may be applied to a meshed wireless network, where a plurality of mesh points (e.g., Access Points) may be coupled together via wired links. One or more embodiments described herein may be applicable in ad hoc operation mode, where the stations (106, 108) may create a network together and communicate directly without an AP. The term “node” may refer to a wireless station (STA), an AP or base station, mesh point, or other wireless computing device, for example. IEEE 802.11 and IEEE 802.21 family of standards or specifications may be used herein to illustrate various example embodiments/. However, the various embodiments are not limited to 802.21 nor 802.11, and may be applied to any wireless technology, including to any wireless specifications or standards.

The various embodiments are applicable to a variety of nodes, including wireless nodes (such as mesh points, stations or STAs) and other types of nodes, and to a variety of networks including wireless networks and wired networks.

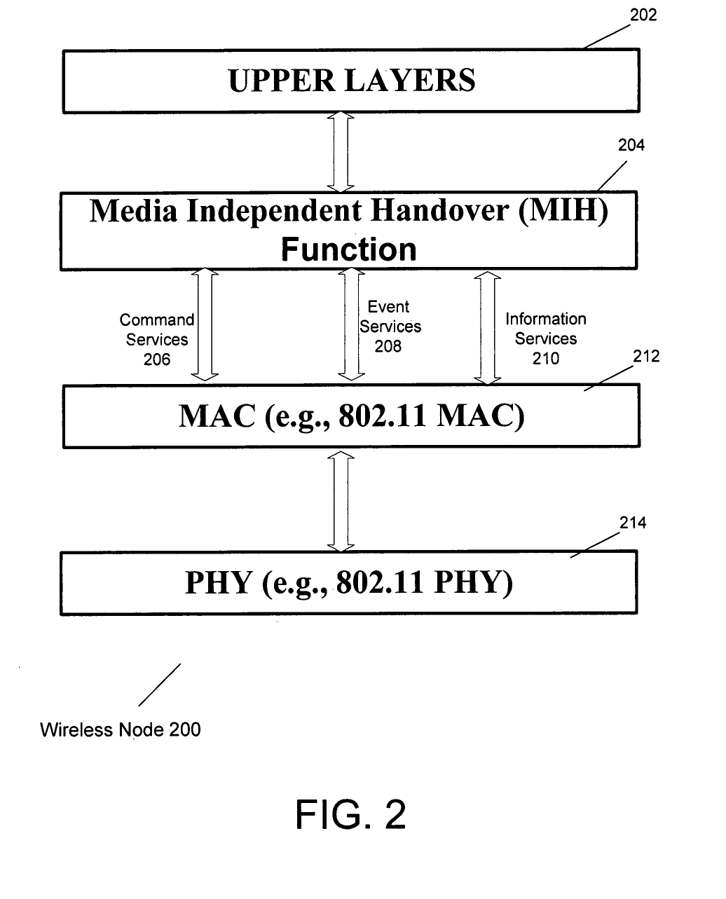

FIG. 2 is a block diagram of a protocol stack which may be provided in a wireless node according to an example embodiment. Wireless node 200 may include for example one or more upper layers 202 (e.g., Internet Protocol, Transport layer protocols, and/or one or more application layers or programs). A MIH function 204 may provide MIH related services such as Command Services (CS) 206 or MICS, Event Services (ES) 208 or MIES, and Information Services (IS) 210 or MIIS, as described above. A Media Access Control (MAC) 212, such as an 802.11 MAC and a PHY (or physical layer) 214, such as an 802.11 PHY may also be provided.

According to an example embodiment, a mechanism may be provided to enable transport of IEEE 802.21 MIH Information Services messages over an IEEE 802.11 link between a station (STA) and an AP before the station is Authenticated and Associated with the AP (state 1). The MIH IS messages, or other messages, may be transported through an existing 802.11 management frame (or other frame), such as by extending use or function of a 802.11 Probe Request/Probe Response management frames (or other management frames), or by providing a new 802.11 management frame (e.g., 802.11 Transport Request/Response frames) for the transport of request and response messages, and the like.

According to an example embodiment, when the MIH function 204 in the terminal (or the AP) would like to send an MIH IS message to the network (to a node or point of attachment), the MIH function 204, for example, may call the MIH_Information.Req primitive defined in 802.21 over MIH_LINK_SAP. As a result, the 802.11 MAC will then typically format the management frame based on the calling function and the SAP (service access point) arguments are formatted to 802.11 Information Elements into the 802.11 management frame that will be used to transport the MIH IS message. In an example embodiment, the 802.11 MAC 212 may receive the MIH IS message as, for example, an MIH Header and a MIH payload, provided as a set of MIH information Elements (IEs) to be transported in the management frame. In an example embodiment, the MIH IEs (the MIH payload) may be transported as payload in one or more 802.11 Information Elements.

In an example embodiment, a new 802.11 Information Element (IE) is defined or provided for each 802.21 Information Element (IE). However this may, in some cases, cause the 802.11 specification to be changed or updated each time a change is made to 802.21, which is not desirable. Therefore, in another example embodiment, a new 802.11 Information Element (IE), referred to as Upper_Layer_Info_Envelope, is provided to carry (or operate as an envelope) or encapsulate the 802.21 IEs (or portions of the MIH messages). The use of a more generic 802.11 Upper_Layer_Info_Envelope IE to carry upper layer information, such as MIH messages, allows for more transparency (e.g., where changes to the 802.21 IEs do not necessarily require changes to the 802.11 specifications).

In addition, in an example embodiment, at least some of the 802.21 MIH IEs for the messages (such as MIIS messages) to be transported may be larger than the largest size for 802.11 IEs. As a result, the 802.11 MAC 212 may perform segmentation, e.g., segment the MIH IS payload into one or more payload segments. The MIH payload segments may be encapsulated into one or more 802.11 Upper_Layer_Info_Envelope IEs for transmission. According to an example embodiment, if the number of bits that can be carried in the Upper_Layer_Info_Envelope IE is x bits, the 802.11 MAC may typically use a sequence of Upper_Layer_Info_Envelope IEs to carry each of the 802.21 IEs. The number of Upper_Layer_Info_Envelope IEs may be, for example, the larger integer greater than Length (all 802.21 IES) divided by x. The 802.11 MAC takes the first x bits of the 802.21 IE and puts it in the first 802.11 IE, then the second x bits and so on. In an example embodiment, the 802.11 IEs used to carry each 802.21 IE may be sequential to simplify the de-segmentation or re-assembly.

In an example embodiment, the MAC 212 of the originating node of the MIH message (e.g., station) may insert the information (e.g., MIH IS payload) obtained from the MIH function 204 as payload in the management frame. At the receiving node (e.g., AP), the 802.11 MAC 212 may re-assemble or reconstruct the MIH message for local processing (e.g., by passing the appropriate parameters to the local MIH function 204 at the receiving node or AP). This mechanism or processing at the receiving node may be symmetrical (but reverse) as compared to the processing performed at the originating node. Alternatively, the re-assembled or reconstructed MIH message (e.g., MIIS message) may be forwarded to an MIH function or server in the network to be processed.

To more easily allow for the reconstruction of the original MIH message at the receiving node, an 802.11 information element, known herein as MIH IS message type, may be provided to identify the MIH message type, or the MIH IS message type. In an example embodiment, an example format for the 802.11 MIH message type IE may be as follows:

| Element ID | Length (Octets) | Information (length) |
|---|---|---|
| TBD | 1 | MIH IS message type |

In an example embodiment, two (or more) types of MIH IS messages may be defined by the MIH IS message type IE, such as an Information Request (Value 00000000) and an Information Response (value of 00000001), for example. Other types of MIH messages may be similarly identified by using different values for the MIH IS message type.

In an example embodiment, the MAC 212 of a node may enable the transport or transmission of some type of MIH messages (e.g., MIH IS messages), while rejecting or inhibiting the transmission of other types of MIH messages (such as MIH ES and CS messages, for example). The transport of ES and CS messages by a node in state 1 (neither Authenticated nor Associated with the destination node or AP) is not generally valid or meaningful. Thus, in some embodiments, it may be desirable to inhibit or preclude the encapsulation and transmission of certain types of MIH messages that are not meaningful or which may not be appropriate for state 1 (e.g., where originating node has not Authenticated and/or Associated with destination node or AP). For example, a station or node in state 1 could attempt to perform a MIH CS registration with an AP. However, if the MIH function in the network were to then send a command to the originating node or station, this command could not be delivered to the station, since it is not Authenticated nor Associated with the AP. The same issues may apply to MIH events (MIH ES).

Thus, in an example embodiment, the MAC 212 of an originating node may determine whether a message (e.g., MIH message) may be transmitted to a wireless node or AP before Authenticating or Associating with such node or AP. In this manner, for example, the MAC 212 of a node may inhibit or prevent the encapsulation and/or the transmission of messages which are improper for transmission while in state 1. Therefore, in one example embodiment, transport of MIH IS messages (or the transport of at least the payloads of the MIH IS messages) in state 1 using an 802.11 management frame is enabled, while transport of MIH ES and CS messages is not enabled while the originating node is in state 1, for example. However, this is simply an example, and the various embodiments are not limited to this example or to these types of messages.

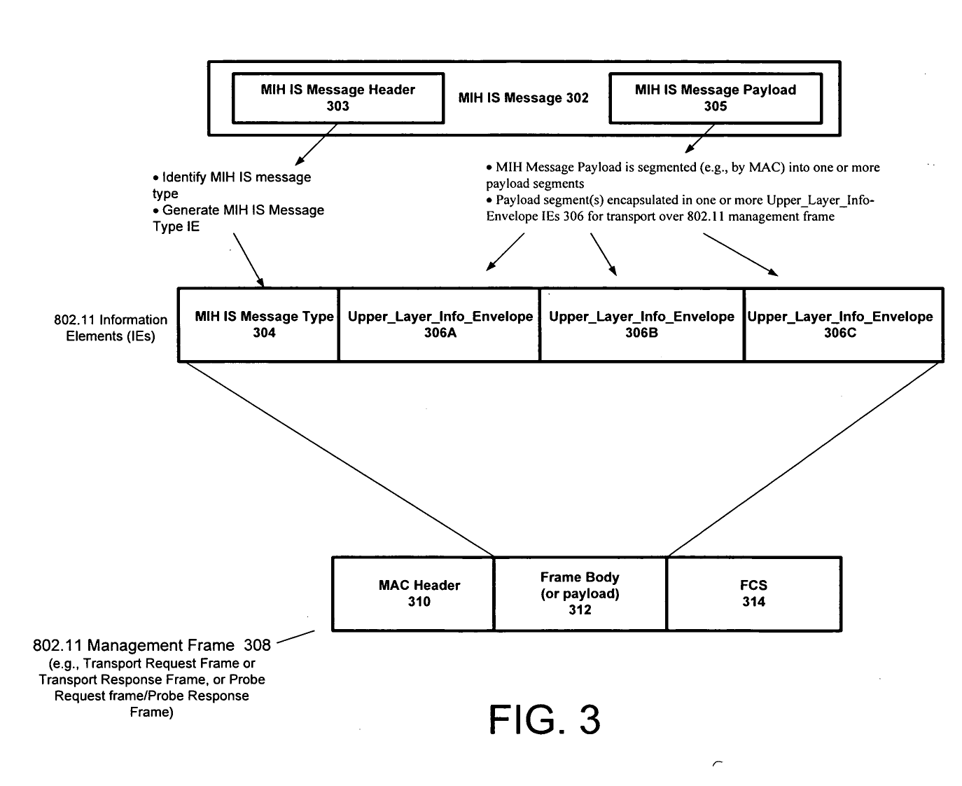

FIG. 3 is a diagram illustrating an encapsulation of a MIH message into a management frame according to an example embodiment. A MIH message, such as a MIH IS message 302 may be generated by an MIH function of a node. At least a portion of the MIH message (e.g., payload of the MIH message) may be encapsulated and transported in a management frame, such as an 802.11 management frame.

In an example embodiment, the MIH IS message 302 may include a MIH IS message header 303 and a MIH IS message payload 305. The MAC 212 of the node may segment the MIH IS message payload 305 into one or more payload segments, as required. The MIH IS message payload 305 may be encapsulated in a management frame by encapsulating each payload segment in a respective 802.11 Upper_Layer_Info_Envelope IE 306, such as envelopes 306A, 306B, 306C, etc. Alternatively, the one or more payload segments may be encapsulated in one or more Upper_Layer_Info_Envelope IEs 306. An 802.11 MIH IS Message Type IE 304 is provided or generated, e.g., by the MAC 212 of the originating node, and identifies the type of MIH message that is encapsulated in the management frame. The MIH IS Message Type IE 304, and the one or more Upper_Layer_Info_Envelope IEs 306 are provided within a payload or frame body 312 of an 802.11 management frame 308, along with other fields. The 802.11 management frame 308 may also include a MAC header 310 and a frame check sequence (FCS) 314, and other information, for example.

As noted above, the 802.11 management frame 308 may be an existing 802.11 management frame (such as a Probe Request/response frames) that has been extended to accommodate or handle the transmission of MIH messages. This approach may, in some cases, increase the complexity of the logic to process or handle such existing frames, since the case where MIH IS frames are encapsulated may be provided. Alternatively, a new 802.11 management frame may be used, such as a Transport Request/Response frames, which may be provided to transport requests and responses, such as for MIH messages, and in some cases, may also be used to transport other messages or information.

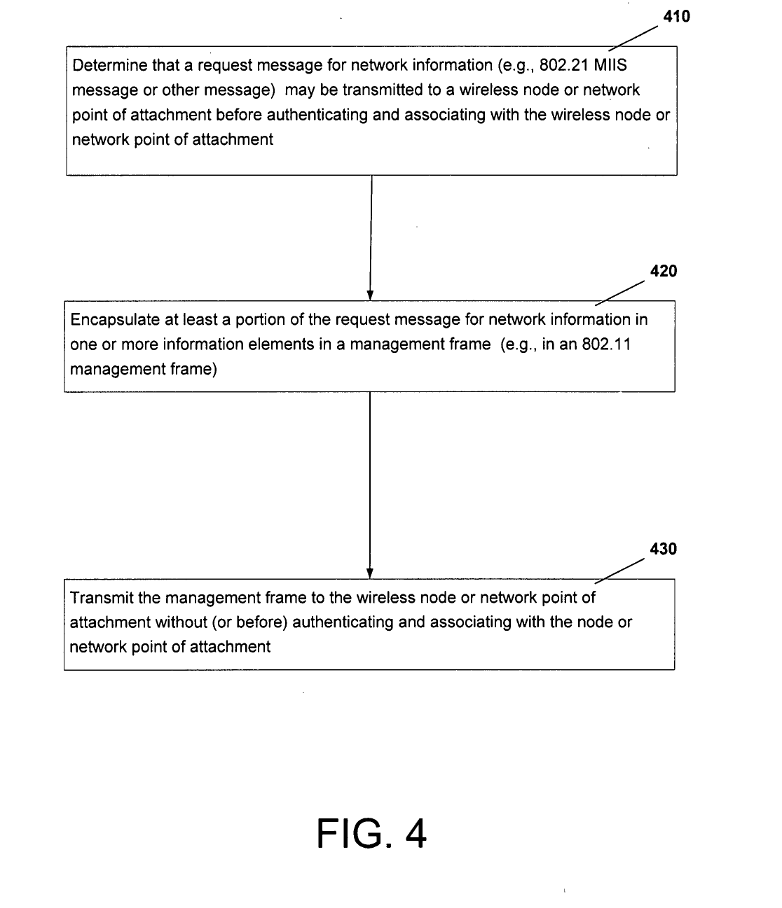

FIG. 4 is a flow chart illustrating operation of a node according to an example embodiment. For example, the flow chart of FIG. 4 may be directed to a technique or method of requesting network information. The method may include: determining that a request message for network information (e.g., 802.21 MIIS message or other message) may be transmitted to a wireless node or network point of attachment before authenticating and associating with the wireless node or point of attachment (410). The method also includes encapsulating at least a portion of the request message (e.g., MIIS message payload) for network information in one or more information elements in a management frame (e.g., in a 802.11 management frame) (420), and transmitting the management frame to the wireless node or network point of attachment without (or before) Authenticating and Associating with the node or point of attachment (430).

In an example embodiment, the payload of the request message may be encapsulated in one or more Information Elements of a management frame. For example, an existing 802.11 management frame, such as a Probe Request/Probe Response may be extended to encapsulate and transmit the payload of the MIIS message. Alternatively, a new or dedicated management frame, such as an 802.11 Transport Request/Response frame may be used. Also, in an example embodiment, the payload of the MIH (or MIIS) request message may be segmented and transported in one or more 802.11 Information Elements designed to carry upper layer information (such as, for example, a new 802.11 Information Element referred to herein as a Upper_Layer_Info_Envelope IE, to carry or transport the payload of the MIH message).

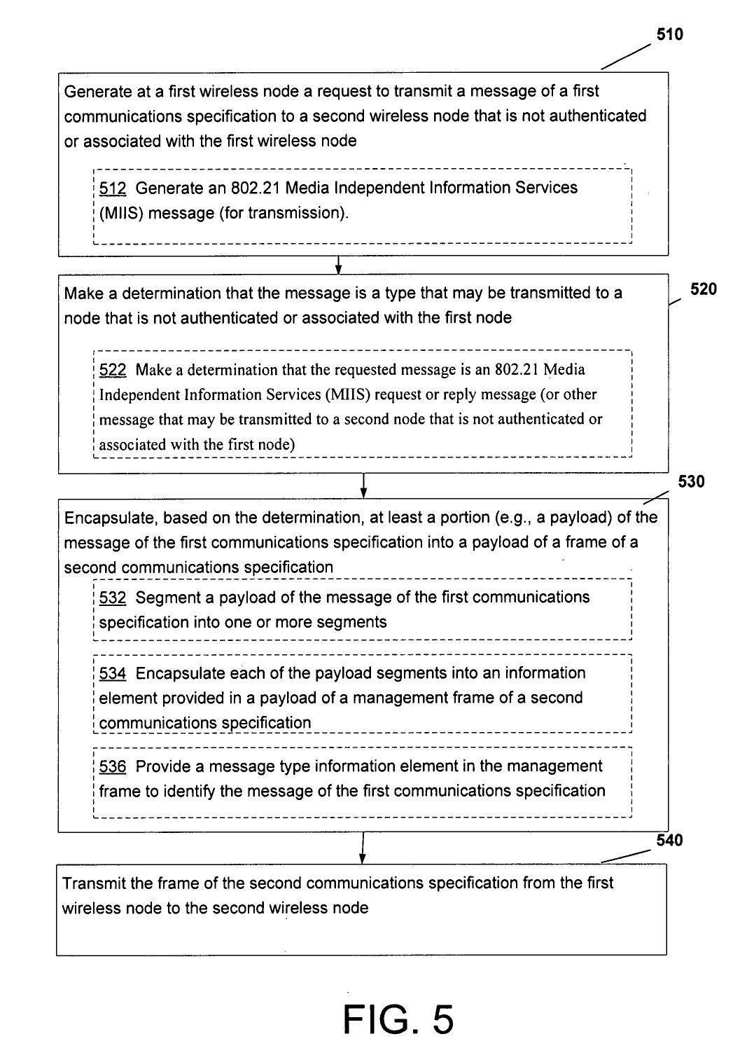

FIG. 5 is a flow chart illustrating a technique or method of operating a node according to an example embodiment. In an example embodiment, the method or technique may include: generating at a first wireless node a request to transmit a message of a first communications interface (or standard, such as 802.21 for example) to a second wireless node that is not Associated with the first wireless node (510). Block 510 may include, for example, generating a 802.21 MIIS message for transmission (512).

The method of FIG. 5 may also include making a determination that the message is a type that may be transmitted to a node that is not Authenticated nor Associated with the first node (520). Block 520 may include, for example, making a determination that the requested message is an 802.21 MIIS request or reply message or other message that may be transmitted to a node that is not Authenticated nor Associated with the first node (522).

The method of FIG. 5 may also include encapsulating, based on the determination, at least a portion of the message of the first communications specification (e.g., payload of an 802.21 MIIS message) into a payload of a frame of a second communications specification (e.g., encapsulating the MIIS message payload into an 802.11 management frame) (530). Block 530 may include, for example: segmenting the message payload of the first communications specification (e.g., 802.21 specification) into one or more segments (532), and encapsulating each of the segments into an information element provided in a payload of a management frame of a second communications specification (e.g., 802.11 specification) (534). Block 530 may also include providing a message type information element in the 802.11 management frame to identify the message of the first communications specification (e.g., to identify the type of MIH message) (536).

The method of FIG. 5 may also include transmitting the frame of the second communications specification from the first wireless node to the second wireless node (540).

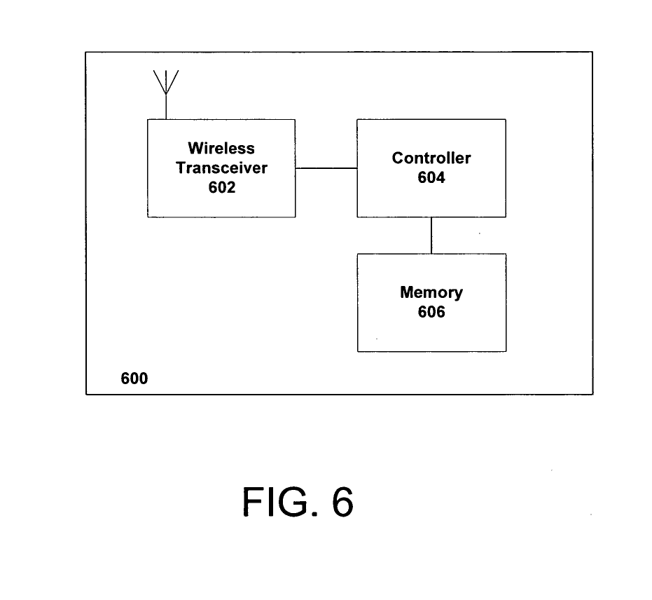

FIG. 6 is a block diagram illustrating an apparatus 600 that may be provided in a wireless station, AP or other node according to an example embodiment. The apparatus may include, for example, a wireless transceiver 602 to transmit and receive signals, a controller 604 to control operation of the station and execute instructions or software, and a memory 606 to store data and/or instructions. Controller 604 may be programmable, and capable of executing software or other instructions stored in memory or on other computer media to perform the various tasks and functions described above. In addition, a storage medium may be provided that includes stored instructions, when executed by a controller or processor that may result in the controller 604 performing one or more of the functions or tasks described above.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

While certain features of the various example embodiments have been illustrated as described herein, many modifications, substitutions, changes and equivalents will now occur to those skilled in the art.

What is claimed is:

1. A method comprising:
generating at a first wireless node a request to transmit a message of a first communications specification to a second wireless node that is not authenticated nor associated with the first wireless node;
making a determination that the message is a type that may be transmitted to a node that is not authenticated nor associated with the first node;
encapsulating, based on the determination, at least a portion of the message of the first communications specification into a payload of a frame of a second communications specification; and
transmitting the frame of the second communications specification from the first wireless node to the second wireless node.

2. The method of claim 1 wherein the generating comprises a Media Independent Handover (MIH) function of the first node generating a Media Independent Information Services (MIIS) request or reply message.

3. The method of claim 1 wherein the generating comprises generating a request for information that may facilitate in selection of networks or nodes during handovers.

4. The method of claim 1 wherein the generating comprises generating an 802.21 Media Independent Information Services (MIIS) message.

5. The method of claim 1 wherein the generating comprises generating a request for one or more of the following:
information about available networks in a geographical area;
address and/or data rate information for a node or network; and
information about capabilities or services of a node or point of attachment for a network.

6. The method of claim 1 wherein the making a determination comprises making a determination that the requested message is an Information Services request to request network information or an Information Services reply message to provide network information, or other message that may be transmitted to the second node while the first node is not authenticated nor associated with the second node.

7. The method of claim 1 wherein the making a determination comprises making a determination that the requested message is an 802.21 Media Independent Information Services (MIIS) request or reply message.

8. The method of claim 1 wherein the encapsulating comprises performing the following if the message is a type that may be transmitted to a node that is not associated with the first node:
segmenting a payload of the message of the first communications specification into one or more segments;
encapsulating each of the segments into an information element provided in a payload of a management frame of a second communications specification; and
providing a message type information element in the management frame to identify the message of the first communications specification.

9. The method of claim 8 wherein the encapsulating each of the segments comprises encapsulating each of the segments into an information element provided in a payload of a Transport Request or Transport Response management frame of a second communications specification.

10. The method of claim 8 wherein the encapsulating each of the segments comprises encapsulating each of the segments into an information element provided in a payload of an 802.11 Transport Request or Transport Response management frame.

11. The method of claim 1 wherein the encapsulating comprises performing the following if the message is a type that may be transmitted to a node that is not associated with the first node:
segmenting a payload of a 802.21 MIH message into one or more segments; and
encapsulating each of the segments into an upper_layer_info_envelope information element provided in a payload of an 802.11 management frame.

12. The method of claim 11 wherein the encapsulating further comprises providing an additional information element in the 802.11 management frame identifying a type of 802.21 MIH message that is encapsulated or provided.

13. The method of claim 1 wherein the making a determination comprises determining whether the message is either a Media Independent Information Services message vs. a Media Independent Event Services message or a Media Independent Command Services message.

14. The method of claim 1 and further comprising:
receiving the transmitted frame at the second wireless node; and
re-assembling and/or rebuilding the message of the first communications specification.

15. The method of claim 14 wherein the re-assembling and/or rebuilding comprises re-assembling an 802.21 Media Independent Information Services message based on one or more information elements in the received frame providing the segmented message payload and an information element identifying a message type.

16. The method of claim 14 and further comprising at least one of:
processing the re-assembled message; and
forwarding the re-assembled message to a third node for processing.

17. The method of claim 14 and further comprising transmitting a reply message from the second node to the first node.

18. The method of claim 17 wherein the transmitting a reply message comprises:
generating at the second wireless node a request to transmit the reply message of the first communications specification to the first wireless node that is not authenticated nor associated with the first wireless node;
making a determination that the reply message is a type that may be transmitted to a node that is not authenticated nor associated with the second node;
encapsulating, based on the determination, at least a portion of the reply message of the first communications specification into a payload of a second frame of the second communications specification; and
transmitting the second frame of the second communications specification from the second wireless node to the first wireless node.

19. An apparatus provided in a first node for wireless communication, the apparatus comprising:
a controller;
a memory coupled to the controller; and
a wireless transceiver coupled to the controller; and
wherein the apparatus is adapted to:
generate a request to transmit a message of a first communications specification to a second wireless node that is not authenticated nor associated with the first wireless node;
make a determination that the message is a type that may be transmitted to a node that is not authenticated nor associated with the first node;
encapsulate, based on the determination, at least a portion of the message of the first communications specification into a payload of a frame of a second communications specification; and
transmit the frame of the second communications specification from the first wireless node to the second wireless node.

20. A method of requesting network information comprising:
determining that a request message for network information may be transmitted to a node before authenticating and associating with the node;
encapsulating at least a portion of the request message for network information in one or more information elements in a management message; and
transmitting the management message to the node.

21. The method of claim 20 wherein the encapsulating the at least the portion of the request message comprises encapsulating a payload of the request message in one or more elements of a management frame.

22. The method of claim 20 wherein the transmitting the management message to the node comprises transmitting the management message to the node without authenticating and associating with the node.

23. The method of claim 20 wherein the encapsulating the at least the portion of the request message comprises encapsulating the at least the portion of the request message in a dedicated management frame.

24. The method of claim 20 further comprising segmenting a payload of the request message and transporting segments of the request message in the one or more information elements.
